(19) United States
(12) Patent Application Publication
(10) Pub. No.: US 2016/0313633 A1
(43) Pub. Date: Oct. 27, 2016

(54) LIGHT SOURCE DEVICE AND PROJECTION-TYPE DISPLAY DEVICE

(71) Applicant: NEC DISPLAY SOLUTIONS, LTD., Tokyo (JP)

(72) Inventor: Atsushi KATO, Tokyo (JP)

(73) Assignee: NEC Display Solutions, Ltd., Tokyo (JP)

(21) Appl. No.: 15/104,520

(22) PCT Filed: Jan. 8, 2014
(86) PCT No.: PCT/JP2014/050112

§ 371 Date: Jun. 14, 2016

(51) Int. Cl. G03B 21/20; G02B 5/02; G02B 27/14

(52) U.S. Cl. CPC G03B 21/204; G02B 27/141; G03B 21/2066; G02B 5/0278

(57) ABSTRACT

A light source device is equipped with a light source main unit, an optical element, a phosphor unit, and a condensing element. The optical axis of the light source main unit is shifted from the optical axis of the condensing element. The reflection direction of light of a first wavelength in a reflecting region intersects direction of the light of the first wavelength incident to the reflecting region. In response to the irradiation of the light of a first wavelength, fluorescent regions emit light of a second wavelength in a direction opposite to the direction of light of the first wavelength incident to the reflecting region and in the direction of reflection of light of the first wavelength in the reflecting region. In addition, fluorescent regions are capable of reflecting light of the second wavelength that is incident to the fluorescent regions. The direction of reflection of light of the second wavelength in the optical element is the same as the direction of light of the first wavelength that has passed through the optical element.

### TECHNICAL FIELD

The present invention relates to a light source device that is provided with a phosphor unit that, in response to the irradiation of light of a first wavelength, emits light of a second wavelength that differs from the light of the first wavelength, and to a projection-type display device that is provided with the light source device.

### BACKGROUND ART

Projection-type display devices are known that use a display panel to modulate light emitted from a light source device to become an image light and that project the image light.

A light source device that is provided with a high-luminance discharge lamp or a light source device that is provided with a solid-state light source that emits visible light of a single wavelength such as an LED (Light Emitting Diode) or semiconductor laser is used as the light source device of this type of projection-type display device. Compared to a discharge lamp, a solid-state light source has limited negative impact on the environment, and light sources devices equipped with solid-state light sources are therefore receiving attention.

Examples of a light source device equipped with a solid-state light source are disclosed in Japanese Unexamined Patent Application Publication No. 2010-237443 (hereinbelow referred to a “Patent Document 1”) and International Publication No. 2012/127554 (hereinbelow referred to as “Patent Document 2”).

Patent Document 1 discloses a light source device that is equipped with a light source main body that emits blue laser light and a phosphor unit that is arranged on the path of advance of the blue laser light and that is further provided with a dichroic mirror between the light source main body and the phosphor unit.

Patent Document 2 discloses a light source device that is equipped with a light source main body that emits blue laser light, a phosphor unit that is arranged on the path of advance of the blue laser light, a dichroic mirror, and a quarter-wave plate. The dichroic mirror is provided between the light source main body and the phosphor unit, and the quarter-wave plate is provided between the phosphor unit and the dichroic mirror.

Neither the light source device that is disclosed in Patent Document 1 nor the light source device that is disclosed in Patent Document 2 use a discharge lamp and both are able to emit light of a plurality of colors in the same direction.

### LITERATURE OF THE PRIOR ART

### Patent Documents

Patent Document 1: Japanese Unexamined Patent Application Publication No. 2010-237443

Patent Document 2: International Publication No. 2012/127554

### SUMMARY OF THE INVENTION

### Problem to be Solved by the Invention

Nevertheless, in the light source device disclosed in Patent Document 1, the phosphor unit allows passage of a portion of the light that is emitted from the light source main body, and a reflecting mirror must therefore be provided on the path of advance of the light that has passed through the phosphor unit. As a result, the scale of this light source device increases with respect to the direction of light incident to the phosphor unit.

In the light source device disclosed in Patent Document 2, moreover, the dichroic mirror must have the characteristic of separating S-polarized light and P-polarized light of a specific wavelength (for example, in the vicinity of 450 nm that is the blue wavelength band) of light that is incident to the phosphor unit. It is extremely difficult to manufacture a dichroic mirror that has this characteristic and such a dichroic mirror is very expensive. As a result, the cost of the light source device increases.

One example of the object of the present invention is the provision of a light source device that can achieve a more compact size with respect to the direction of irradiation of light to the phosphor unit, and further, that is less expensive.

### Means for Solving the Problem

According to one aspect of the present invention, a light source device is equipped with a light source main body, an optical element, a phosphor unit, and a condensing element. The light source main body emits light of a first wavelength. The optical element is provided on the path of advance of the light of the first wavelength that is emitted from the light source main body. The optical element both transmits the light of the first wavelength and reflects light of a second wavelength that differs from the first wavelength. The phosphor unit includes a reflecting region that reflects light and a fluorescent region that emits light of the second wavelength when irradiated by light of the first wavelength. The phosphor unit is provided such that light of the first wavelength that is transmitted through the optical element sequentially irradiates the reflecting region and the fluorescent region. The condensing element both converts the light of the second wavelength that is emitted from the fluorescent region to parallel light and condenses light of the second wavelength that is reflected at the optical element. The optical axis of the light source main body is shifted from the optical axis of the optical element. The direction of reflection of the light of the first wavelength in the reflecting region intersects the direction of the light of the first wavelength incident to the reflecting region. In response to the irradiation by light of the first wavelength, the fluorescent region emits light of the second wavelength in a direction opposite to the direction of the first wavelength incident to the reflecting region and in the direction of reflection of light of the first wavelength in the reflecting region. In addition, the fluorescent region is capable of reflecting light of the second wavelength that is incident to the fluorescent region. Finally the direction of reflection of light of the second wavelength in the optical element is the same as the direction of light of the first wavelength that was transmitted by the optical element.

### Effect of the Invention

The light source device of the present invention realizes both a more compact size with respect to the direction of irradiation of light to the phosphor unit as well as a lower cost.

### BRIEF DESCRIPTION OF THE DRAWINGS

FIG. 1 is a schematic upper plan view of a light source device according to a first exemplary embodiment of the present invention.

FIG. 2 is a graph showing the characteristics of the optical element.

FIG. 3 is a frontal view of the phosphor unit shown in FIG. 1.

FIG. 4 is a frontal view of the diffusion unit.

FIG. 5 is a schematic view of a projection-type display device that is equipped with the light source device shown in FIG. 1.

FIG. 6 is a view for describing the path of light inside the light source device according to the first exemplary embodiment.

FIG. 7 is a view for describing the path of light in the light source device according to the first exemplary embodiment.

FIG. 8 is a schematic upper plan view of the light source device according to the second exemplary embodiment of the present invention.

FIG. 9 is a view for describing the path of advance of light inside the light source device according to the second exemplary embodiment.

FIG. 10 is a view for describing the path of light inside the light source device according to the second exemplary embodiment.

FIG. 11 is a schematic upper plan view of the light source device according to the third exemplary embodiment of the present invention.

FIG. 12 is a frontal view of the phosphor unit shown in FIG. 11.

FIG. 13 is a frontal view of the separation unit.

FIG. 14 is a view for describing the lens system for converting light emitted by a plurality of light source main bodies to a plurality of parallel light beams of small diameter.

### BEST MODE FOR CARRYING OUT THE INVENTION

Exemplary embodiments of the present invention are next described with reference to the accompanying drawings.

### First Exemplary Embodiment

The light source device according to the first exemplary embodiment is first described using FIGS. 1 to 4. FIG. 1 is a schematic upper plan view of the light source device according to the present exemplary embodiment. As shown in FIG. 1, light source device 1 according to the present exemplary embodiment is equipped with light source main body 2, optical element 3, phosphor unit 4, reflecting mirror 5, and rod integrator 6.

Light source main body 2 emits light of a first wavelength. The light of the first wavelength is laser light having a wavelength of, for example, 450 nm. The light of the first wavelength is not limited to laser light having a wavelength of 450 nm, and may also be laser light having a wavelength of, for example, 410 nm, or 460 nm A blue semiconductor laser light source is capable of emitting this type of laser light and can also be readily acquired.

As light source main body 2, the blue semiconductor laser light source emits light that spreads at a predetermined angle. Collimator lens 7 is provided on the path of advance of the light that is emitted from light source main body 2, whereby the spread of light emitted from light source main body 2 is controlled and a parallel light beam is formed.

In the example shown in FIG. 1, the lens system that converts the light from light source main body 2 to a parallel light beam is formed by a single planoconvex lens, but this lens system may also be made up using a plurality of lenses.

Optical element 3 transmits light of the first wavelength (for example, blue light) and reflects light of the second wavelength (for example, green or red light) that differs from the light of the first wavelength. For example, optical element 3 is formed by vapor deposition, on a transparent glass plate, of a dielectric multilayered film that reflects light of the green or red wavelength band and transmits light of the blue wavelength band.

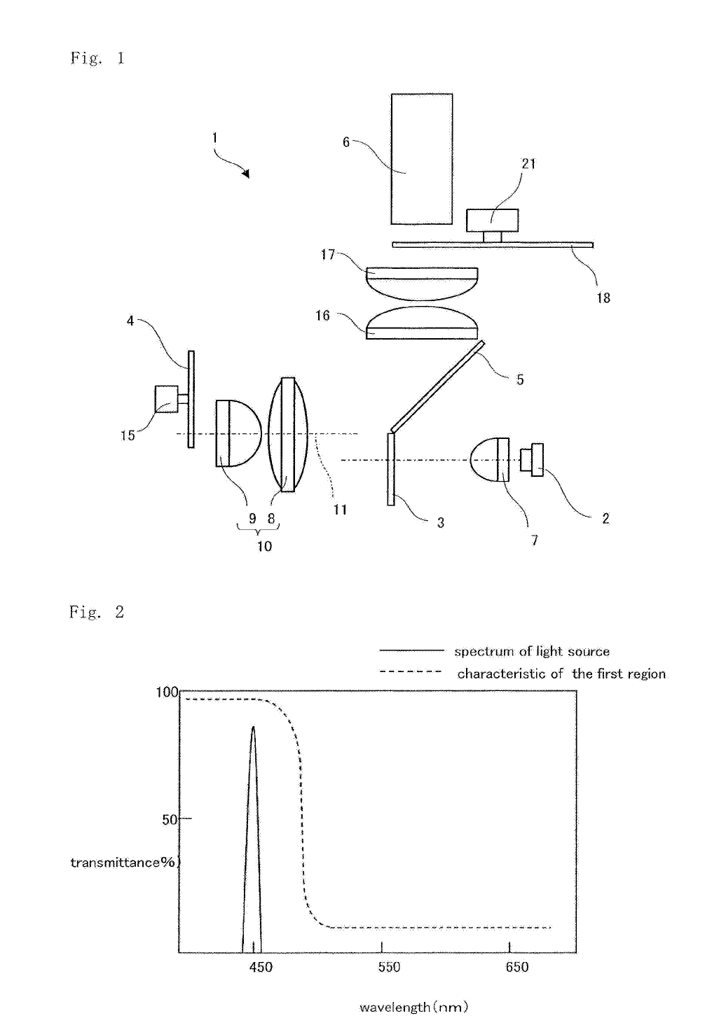

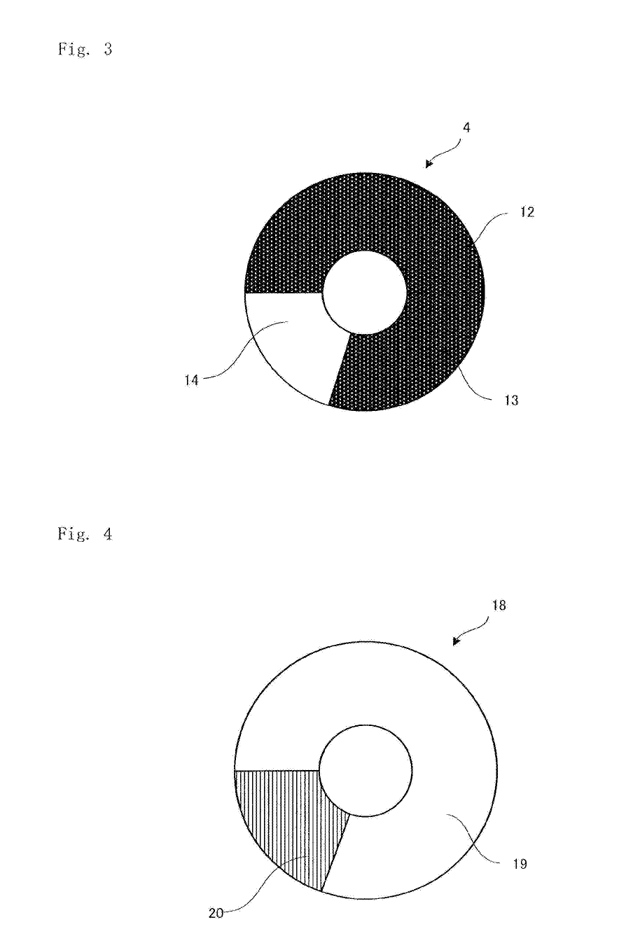

FIG. 2 is a graph showing the characteristics of optical element 3, i.e., the characteristics of the dielectric multilayered film that was vapor-deposited on a glass plate. The horizontal axis shows wavelength and the vertical axis shows the transmittance. This type of dielectric multilayered film is typically used in a liquid crystal projector and can be readily acquired.

Optical element 3 having the characteristics shown in FIG. 2 is referred to as a dichroic mirror.

Again referring to FIG. 1, optical element 3 is provided on the path of advance of light emitted from light source main body 2. Accordingly, light of the first wavelength emitted from light source main body 2 passes through optical element 3 and is directed to phosphor unit 4.

Lenses 8 and 9 are arranged between optical element 3 and phosphor unit 4. Optical glass or optical resin can be used as the material of lenses 8 and 9.

Lenses 8 and 9 form condensing element 10 that condenses the light beam. More specifically, upon incidence of diverging rays, condensing element 10 converts the diverging rays to parallel light that is parallel to optical axis 11 of condensing element 10. Further, upon incidence of parallel light, optical element 10 condenses the parallel light to a point on optical axis 11 of optical element 10.

Condensing element 10 may also be made up of one lens or three or more lenses. In addition, condensing element 10 may also be formed using a lens having an other than spherical surface such as an aspheric surface or free-form surface.

The optical axis of light source main body 2, i.e., the optical axis of light of the first wavelength that has passed through optical element 3 is shifted from optical axis 11 of condensing element 10. Accordingly, light of the first wavelength that has passed through optical element 3 is incident to condensing element 10 at a position separated from optical axis 11 of condensing element 10. The light of the first wavelength that has passed through optical element 3 is then refracted in a direction that approaches optical axis 11 in condensing element 10 and that is directed toward phosphor unit 4.

Phosphor unit 4 contains a glass plate having a round shape. FIG. 3 is a front view of phosphor unit 4. As shown in FIG. 3, phosphor unit 4 includes fluorescent regions 12 and 13 and reflecting region 14.

Referring to FIGS. 1 and 3, phosphor unit 4 is provided such that light of the first wavelength that has passed through optical element 3 sequentially irradiates fluorescent regions 12 and 13 and reflecting region 14.

In the present exemplary embodiment, phosphor unit 4 is linked to motor 15. By the operation of motor 15, phosphor unit 4 rotates around the axis of rotation of motor 15. Fluorescent regions 12 and 13 and reflecting region 14 are aligned in the direction of rotation of phosphor unit 4. Accordingly, the rotation of phosphor unit 4 causes the light that has passed through optical element 3 to sequentially irradiate fluorescent regions 12 and 13 and reflecting region 14.

Reflecting region 14 reflects the light that is incident to reflecting region 14. Accordingly, light of the first wavelength that irradiates reflecting region 14 is reflected at reflecting region 14 and remains unchanged as light of the first wavelength.

Phosphor unit 4 is provided such that the direction of reflection of light of the first wavelength in reflecting region 14 intersects the direction of light of the first wavelength incident to reflecting region 14. More specifically, reflecting region 14 has a planar shape, and phosphor unit 4 is arranged such that the direction of light of the first wavelength that is incident to reflecting region 14 is inclined with respect to the perpendicular of reflecting region 14.

Light of the first wavelength that is reflected at reflecting region 14 is directed toward reflecting mirror 5 by way of condensing element 10.

In accordance with the irradiation of light of the first wavelength (for example, blue light), fluorescent regions 12 and 13 emit light of the second wavelength (for example, green or red light) that differs from the light of the first wavelength. For example, fluorescent regions 12 and 13 are each formed by causing a fluorescent material that emits fluorescent light, when irradiated by blue laser light, to adhere to a predetermined region of a glass plate.

In the present exemplary embodiment, fluorescent region 12 is a green fluorescent region formed by causing a fluorescent material that emits green fluorescent light, when irradiated by blue laser light, to adhere to a glass plate. In addition, fluorescent region 13 is a red fluorescent region formed by causing a fluorescent material that emits red fluorescent light, when irradiated by blue laser light, to adhere to a glass plate.

The light emitted by the fluorescent material is diverging rays. Accordingly, light of the second wavelength that is emitted from fluorescent regions 12 and 13 in response to the irradiation of light of the first wavelength advances in at least a first direction that is opposite to the direction of light of the first wavelength incident to reflecting region 14 and a second direction that is identical to the direction of reflection of light of the first wavelength in the reflecting region.

Light of the second wavelength that is emitted from fluorescent regions 12 and 13 is converted to parallel light in condensing element 10 and directed toward optical element 3 and reflecting mirror 5. Optical element 3 has the characteristic of reflecting light of the second wavelength (see FIG. 2), and light of the second wavelength that is directed toward optical element 3 is therefore reflected in optical element 3.

Optical element 3 is arranged such that the direction of reflection of light of the second wavelength in optical element 3 is identical to the direction of light of the first wavelength that is transmitted through optical element 3. Light of the second wavelength that is reflected in optical element 3 is thus directed toward condensing element 10.

The light of the second wavelength that is reflected in optical element 3 is parallel light. Condensing element 10 accordingly guides the light of the second wavelength toward fluorescent regions 12 and 13 while causing convergence of the light of the second wavelength.

Fluorescent regions 12 and 13 can cause diffused reflection of the light of the second wavelength that is incident to fluorescent regions 12 and 13. A portion of the light of the second wavelength that has been reflected diffusely in fluorescent regions 12 and 13 advances in the first direction and the other portion advances in the second direction. This portion of light is reflected by optical element 3 and is again incident to fluorescent regions 12 and 13.

Fluorescent regions 12 and 13 may also be capable of regularly reflecting the light of the second wavelength that is irradiated into fluorescent regions 12 and 13. In other words, fluorescent regions 12 and 13 may also be capable of reflecting the light of the second wavelength that is incident to fluorescent regions 12 and 13.

Reflecting mirror 5 is an extremely typical component having the characteristic of reflecting visible light. For example, reflecting mirror 5 is fabricated by vapor deposition of aluminum, chrome, or silver on a planar material.

Optical element 3 is preferably arranged only closer to the side of the location where light of the first wavelength is incident to condensing element 10 than to optical axis 11 of condensing element 10. In addition, reflecting mirror 5 is preferably arranged only closer to the side that is opposite from the location of incidence than optical axis 11 of condensing element 10.

Light of the first and second wavelengths that is directed toward reflecting mirror 5 from phosphor unit 4 is reflected in reflecting mirror 5 and directed toward rod integrator 6. Lenses 16 and 17 are arranged between reflecting mirror 5 and rod integrator 6, and diffusion unit 18 is arranged between rod integrator 6 and lens 16.

Lenses 16 and 17 form a lens system that focuses the light that is directed toward rod integrator 6 onto the incident surface of rod integrator 6. Optical glass or optical resin can be used as the material of lenses 16 and 17.

The lens system that focuses light into rod integrator 6 may also be made up of one lens or three or more lenses. In addition, this lens system may also be formed using a lens using a lens whose surface is other than a spherical surface, such as an aspheric surface or a free-form surface.

Rod integrator is a component having a prism shape. Optical glass or optical resin can be used as the material of rod integrator 6.

Although not shown in FIG. 1, a component in which four reflecting mirrors are combined (also referred to as a light tunnel) may also be used in place of rod integrator 6.

Alternatively, an integrator composed of two fly-eye lenses can be used in place of rod integrator 6. In this case, the lens system that focuses light into the integrator is formed using at least one lens whose shape differs from the shapes of lenses 16 and 17.

Diffusion unit 18 includes a transparent plate (for example, a glass plate) having a round shape. FIG. 4 is a frontal view of diffusion unit 18. As shown in FIG. 4, diffusion unit 18 includes transmission region 19 and diffusion region 20.

Transmission region 19 allows the passage of irradiated light without diffusion. Diffusion region 20 allows the passage of light while diffusing the irradiated light.

Referring to FIG. 1 and FIG. 4, diffusion unit 18 is provided such that light emitted from lens 17 is sequentially irradiated into transmission region 19 and diffusion region 20.

In the present exemplary embodiment, diffusion unit 18 is linked to motor 21. The operation of motor 21 causes diffusion unit 18 to rotate around the axis of rotation of motor 21. Transmission region 19 and diffusion region 20 are aligned along the direction of rotation of diffusion unit 18, whereby the rotation of diffusion unit 18 causes light that is emitted from lens 17 to sequentially irradiate transmission region 19 and diffusion region 20.

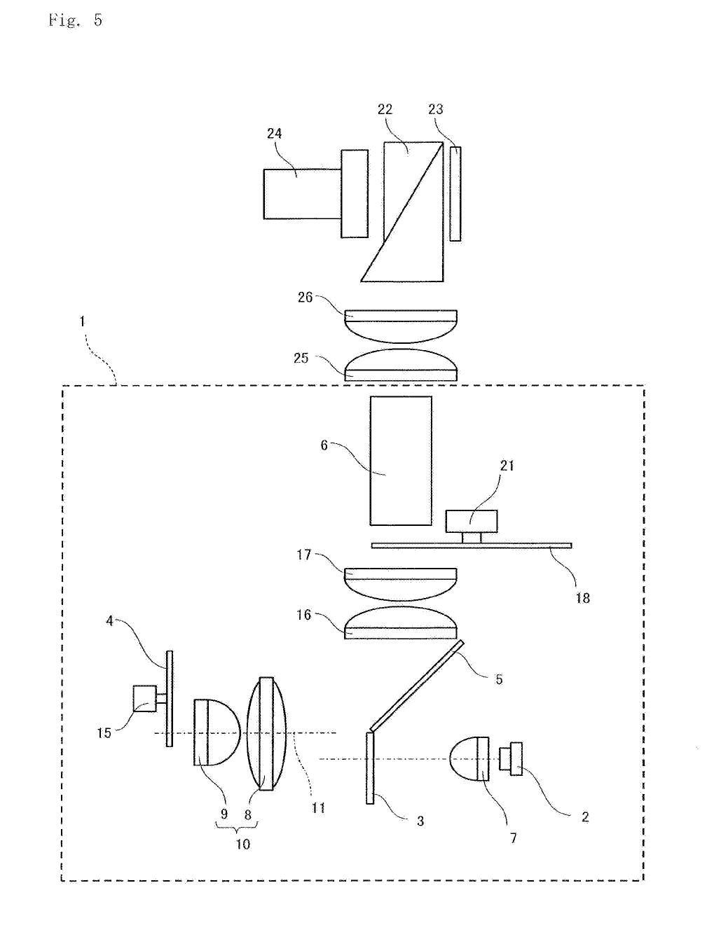

FIG. 5 is a schematic view of a projection-type display device that is equipped with light source device 1. As shown in FIG. 5, the projection-type display device is equipped with TIR (Total Internal Reflector) prism 22, display panel 23, projection lens 24, and lenses 25 and 26.

TIR prism 22 is provided on the path of light that is emitted by rod integrator 6 and both emits light both from rod integrator 6 toward display panel 23 and emits light from display panel 23 toward projection lens 24.

A DMD (Digital Micromirror Device) can be used as display panel 23. When a DMD is used, light must be irradiated into DMD at a specific angle. The use of TIR prism 22 enables irradiation of light into DMD at a specific angle. The use of TIR prism 22 is very typical in a projection-type display device that is provided with DMD.

Lenses 25 and 26 are disposed on the path of light emitted from rod integrator 6. Lenses 25 and 26 form an image of the emission surface of rod integrator 6 on display panel 23. The number and shapes of lenses 25 and 26 are varied as appropriate according to, for example, the area of the emission surface of rod integrator 6.

The light emitted from light source device 1 is modulated to an image using display panel 23 and guided to projection lens 24. Projection lens 24, by projecting the light, enlarges and displays the image.

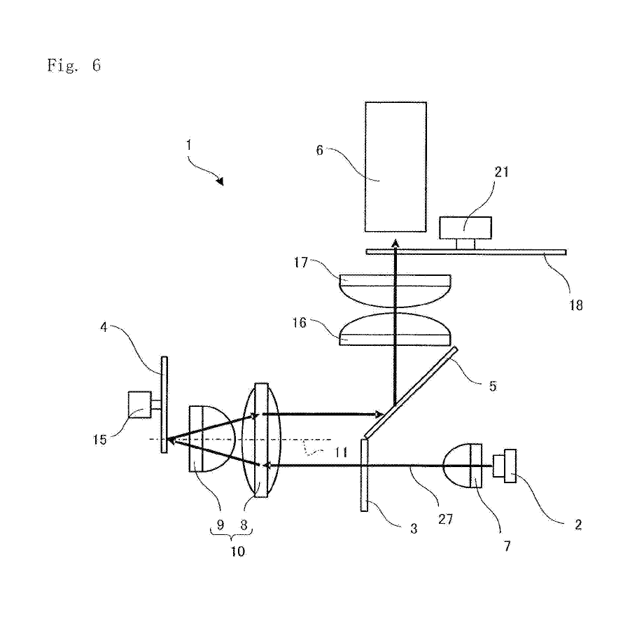

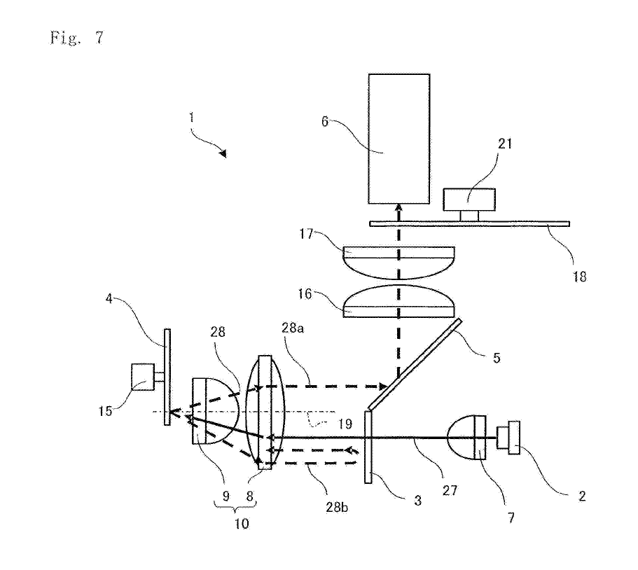

The operation of light source device 1 according to the present exemplary embodiment is next described using FIGS. 3, 4, 6, and 7. FIGS. 6 and 7 are views for describing the path of light inside light source device 1.

As shown in FIGS. 6 and 7, the light of the first wavelength 27 (blue laser light) that is emitted from light source main body 2 is made substantially parallel by collimator lens 7 and then arrives in optical element 3. Optical element 3 has the characteristic of transmitting light of the first wavelength 27 (see FIG. 2), and light of the first wavelength 27 therefore passes through optical element 3 and is directed to condensing element 10.

The optical axis of light source main body 2 and optical axis 11 of condensing element 10 are shifted, and light of the first wavelength 27 that has passed through optical element 3 is therefore incident to condensing element 10 at a position that is away from optical axis 11 of condensing element 10 and refracted in condensing element 10. As a result, the direction of light of the first wavelength 27 that is incident to phosphor unit 4 by way of condensing element 10 is inclined with respect to the surface of incidence of phosphor unit 4.

The operation of light source device 1 differs according to whether fluorescent regions 12 and 13 are positioned on the path of light of the first wavelength 27 or reflecting region 14 is positioned on the path of light of the first wavelength 27 at the time that light of the first wavelength 27 reaches phosphor unit 4, and the description of the operation is therefore divided between these two cases.

The case in which reflecting region 14 of phosphor unit 4 is positioned on the path of light of the first wavelength 27 is first described using FIGS. 3, 4, and 6.

Because reflecting region 14 is positioned on the path of light of the first wavelength 27, light of the first wavelength 27 is reflected by phosphor unit 4. The direction of light of the first wavelength 27 that is incident to reflecting region 14 is inclined with respect to the surface of incidence of phosphor unit 4, and light of the first wavelength 27 that is reflected in reflecting region 14 therefore advances in a direction that intersects the direction of light of the first wavelength 27 incident to reflecting region 14 and is directed toward condensing element 10.

Light of the first wavelength 27 that is again irradiated into condensing element 10 is refracted by condensing element 10 and directed toward reflecting mirror 5. Light of the first wavelength 27 that is reflected by reflecting mirror 5 arrives at diffusion unit 18 by way of lenses 16 and 17.

Diffusion unit 18 rotates in accordance with the rotation of phosphor unit 4. More specifically, when reflecting region 14 is positioned on the path of advance of light of the first wavelength 27 that is incident to phosphor unit 4, the rotation of diffusion unit 18 is controlled such that diffusion region 20 is positioned on the path of advance of light of the first wavelength 27 that is incident to diffusion unit 18. Accordingly, light of the first wavelength 27 that is incident to diffusion unit 18 is diffused by diffusion region 20 and irradiated to rod integrator 6.

Light of the first wavelength 27 that is incident to rod integrator 6 is repeatedly reflected inside rod integrator 6 to become a uniform light beam, emitted from rod integrator 6, and then irradiated into an optical component referred to as display panel 23 (see FIG. 5).

Cases in which fluorescent regions 12 and 13 of phosphor unit 4 are positioned on the path of light of the first wavelength 27 that is incident to phosphor unit 4 are next described using FIGS. 3, 4, and 7.

Because fluorescent region 12 or 13 is positioned on the path of light of the first wavelength 27 that is incident to phosphor unit 4, light of the first wavelength 27 irradiates fluorescent region 12 or 13. As a result, fluorescent region 12 or 13 emits light of the second wavelength 28 that differs from the first wavelength. In the present exemplary embodiment, fluorescent region 12 emits green fluorescent light and fluorescent region 13 emits red fluorescent light.

In FIG. 7, light of the second wavelength 28 is depicted by a broken line to distinguish this light from light of the first wavelength 27.

Fluorescent regions 12 and 13 that emit light of the second wavelength 28 when irradiated by light of the first wavelength 27 are also considered to be secondary light sources that take light source main body 2 as the excitation source. Light of the second wavelength 28 that is emitted from fluorescent regions 12 and 13 advances in all directions from the position of irradiation of light of the first wavelength 27 while spreading, particularly toward condensing element 10.

Light of the second wavelength 28 that is incident to condensing element 10 is converted to parallel light through the use of condensing element 10 and is directed toward optical element 3 and reflecting mirror 5.

Of light of the second wavelength 28 that is emitted from fluorescent regions 12 and 13, light that is directed toward reflecting mirror 5 (this light is hereinbelow referred to as “light 28a”) is reflected by reflecting mirror 5 and reaches diffusion unit 18 by way of lenses 16 and 17.

Of light of the second wavelength 28 that is emitted from fluorescent regions 12 and 13, light that is directed toward optical element 3 (this light is hereinbelow referred to as “light 28b”) is reflected at optical element 3. The direction of reflection of light of the second wavelength in optical element 3 is the same as the direction of light of the first wavelength that is transmitted through optical element 3, and light of the second wavelength that is reflected in optical element 3 is again directed toward condensing element 10.

Light 28b that is again incident to condensing element 10 is directed toward phosphor unit 4 and reaches fluorescent regions 12 and 13. Light 28b that is incident to fluorescent regions 12 and 13 is reflected diffusely in fluorescent regions 12 and 13 and therefore again directed toward condensing element 10. In other words, fluorescent regions 12 and 13 function as secondary light sources that emit light in response to the irradiation of light 28b.

A portion of light 28b that is irradiated into fluorescent regions 12 and 13 advances along the path of advance of light 28a and is directed toward rod integrator 6.

The light that is directed toward optical element 3 of light 28b that was irradiated into fluorescent regions 12 and 13 is again irradiated into fluorescent regions 12 and 13. Due to the repetition of irradiation of fluorescent regions 12 and 13 and reflection in optical element 3, the major portion of light of the second wavelength 28 that is emitted from fluorescent regions 12 and 13 is directed toward rod integrator 6.

Diffusion unit 18 rotates in correspondence with the rotation of phosphor unit 4. More specifically, when fluorescent regions 12 and 13 are positioned on the path of advance of light of the first wavelength 27 that enters phosphor unit 4, the rotation of diffusion unit 18 is controlled such that transmission region 19 is positioned on the path of advance of light 28a that is incident to diffusion unit 18. Accordingly, light 28a that is incident to diffusion unit 18 passes through transmission region 19 and is then incident to rod integrator 6.

Light of first and second wavelength 27 and 28 that is incident to rod integrator 6 is repeatedly reflected inside rod integrator 6 to become a uniform light beam, emitted from rod integrator 6, and then irradiated into the optical component referred to as display panel 23 (see FIG. 5). A color image can be projected by controlling the modulation of display panel 23 (see FIG. 5) to synchronize with the color of light emitted by source device 1.

In light source device 1 according to the present exemplary embodiment, light of the first wavelength 27 that is emitted from light source main body 2 does not pass through phosphor unit 4. Accordingly, light source device 1 does not need a reflecting mirror on the side of phosphor unit 4 that is opposite to the side at which light is incident. As a result, light source device 1 can be made more compact with respect to the direction of irradiation of light into phosphor unit 4.

In addition, because the direction of reflection of light of the first wavelength 27 in reflecting region 14 intersects the direction of light of the first wavelength 27 incident to reflecting region 14, light source device 1 does not need a dichroic mirror that separates light of the first wavelength 27 into an S-polarization component and P-polarization component. Accordingly, light source device 1 can be fabricated from less expensive components and the cost of the light source device can be reduced.

Still further, of light of the second wavelength 28 that is emitted from fluorescent regions 12 and 13, light 28b that is directed toward light source main body 2 is again incident to fluorescent regions 12 and 13 through the use of optical element 3, whereby more light of the second wavelength 28 can be directed in the same direction as light of the first wavelength 27.

Still further, because the present exemplary embodiment has condensing element 10 that converts light of the second wavelength 28 that is emitted from fluorescent regions 12 and 13 into parallel light, most of light of the second wavelength 28 is directed toward optical element 3 and reflecting mirror 5. As a result, virtually none of light of the second wavelength 28 that is emitted from fluorescent regions 12 and 13 is lost and brighter light of the second wavelength 28 can be emitted in the same direction as light of the first wavelength 27.

However, the use of laser light to project an image may result in the occurrence of so-called speckle noise that is caused by the coherence of laser light, and the quality of the projected image may therefore be reduced.

According to the present exemplary embodiment, diffusion region 20 diffuses laser light and therefore greatly mitigates the speckle noise of the light of the first wavelength. Accordingly, an image is projected using light that contains almost no speckle noise and the quality of the projected image is improved.

In particular, because diffusion unit 18 is rotating, the portion that is irradiated by light of the first wavelength in diffusion region 20 changes with the passage of time. Accordingly, speckle is substantially reduced.

In the present exemplary embodiment, moreover, the provision of reflecting mirror 5 that changes the direction of light of the first and second wavelengths 27 and 28 from the phosphor unit enables free alteration of the designed position of rod integrator 6.

Finally, diffusion unit 18 may be positioned on the path of light that is emitted from rod integrator 6.

### Second Exemplary Embodiment

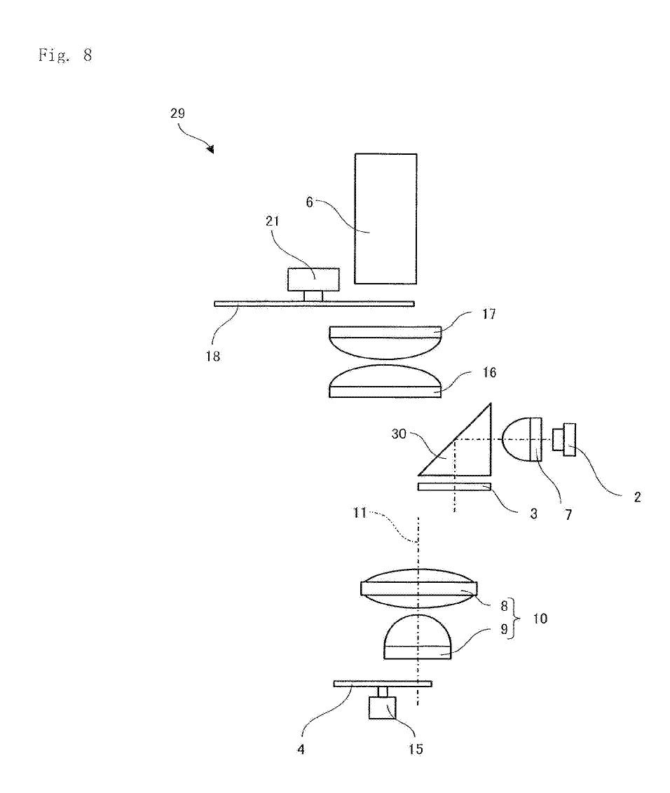

The light source device according to the second exemplary embodiment of the present invention is next described using FIG. 8. Elements that are identical to constituent elements of the first exemplary embodiment are given the same reference numbers and redundant explanation is omitted.

FIG. 8 is a schematic upper plan view of the light source device according to the present exemplary embodiment. As shown in FIG. 8, in light source device 29 according to the present exemplary embodiment, the light direction of the first wavelength that is transmitted through optical element 3 intersects substantially perpendicular to the light direction of the first wavelength that is emitted from light source main body 2. Light source device 29 is equipped with light path conversion element 30 that guides light of the first wavelength that is emitted from light source main body 2 to optical element 3.

Light source device 29 is not provided with reflecting mirror 5 shown in FIG. 1. Accordingly, light advances straight from phosphor unit 4 as far as rod integrator 6.

Light source main body 2 emits light of the first wavelength. The light of the first wavelength that is emitted from light source main body 2 is converted to substantially parallel light using collimator lens 7. The light of the first wavelength that is emitted from collimator lens 7 is irradiated into light path conversion element 30 and then emitted from light path conversion element 30 toward optical element 3.

In this document, the optical axis of light source main body 2 is assumed to contain the optical axis of light that is emitted from light path conversion element 30.

A right-angle triangular prism can be used as light path conversion element 30. A right-angle triangular prism made of optical glass is relatively inexpensive and relatively easily acquired. A reflecting mirror may also be used as light path conversion element 30.

Although optical element 3 is separated from light path conversion element 30 in the example shown in FIG. 8, optical element 3 may also be arranged in proximity to light path conversion element 30 or may be adhered to light path conversion element 30. A dichroic film having the characteristics shown in FIG. 2 may also be vapor deposited on the surface of emission of light path conversion element 30.

The optical axis of light source main body 2 is shifted from optical axis 11 of condensing element 10. Accordingly, light of the first wavelength that has passed through optical element 3 is irradiated into condensing element 10 at a position separate from optical axis 11 of condensing element 10. Light of the first wavelength that has passed through optical element 3 is refracted in a direction that approaches optical axis 11 in condensing element 10 and directed toward phosphor unit 4.

Optical element 3 and light path conversion element 30 are preferably arranged only on the side of position of incidence of light of the first wavelength to condensing element 10 from optical axis 11 of condensing element 10.

The configuration and operation of condensing element 10, phosphor unit 4, lenses 16 and 17, diffusion unit 18, and rod integrator are the same as in the first exemplary embodiment and explanation of these components is therefore here omitted.

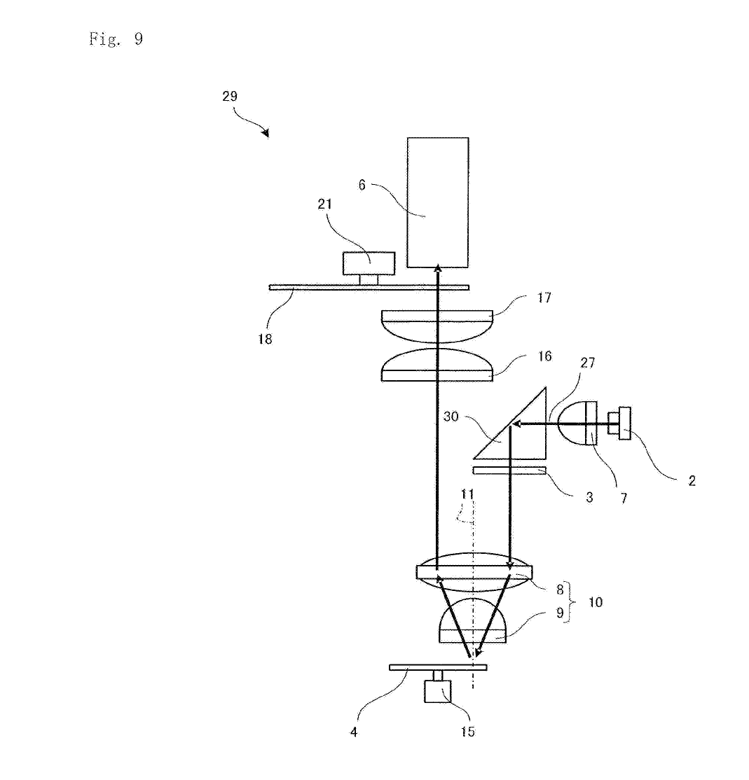

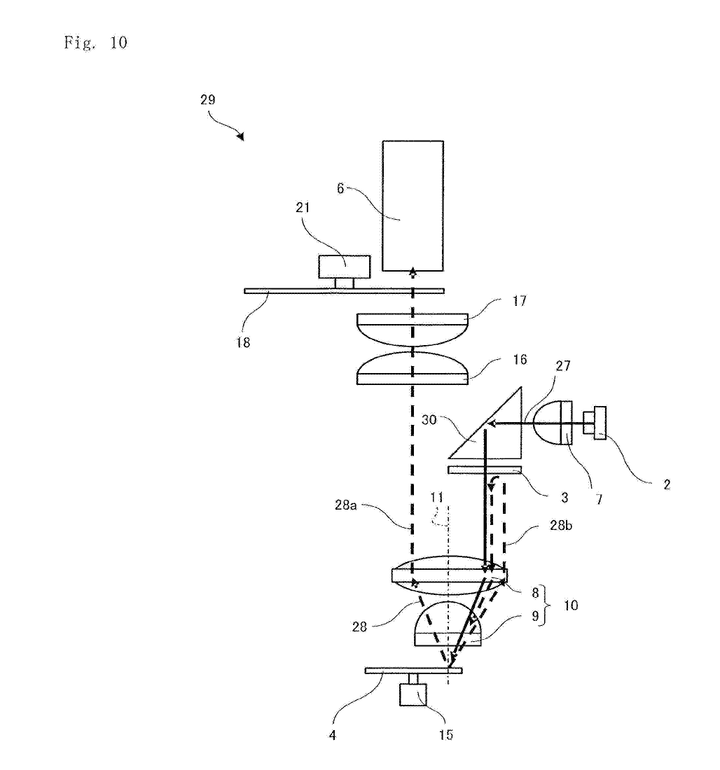

The operation of light source device 29 is next described using FIGS. 3, 4, 9, and 10. FIGS. 9 and 10 are views for describing the path of light inside light source device 29.

As shown in FIGS. 9 and 10, light of the first wavelength 27 (blue laser light) that is emitted from light source main body 2 reaches light path conversion element 30 after having been made substantially parallel in collimator lens 7. Light of the first wavelength 27 that is irradiated into light path conversion element 30 is emitted in the direction of optical element 3.

Optical element 3 has the characteristic of transmitting light of the first wavelength 27 (see FIG. 2), and light of the first wavelength 27 is therefore transmitted through optical element 3 and directed toward condensing element 10.

The optical axis of light source main body 2 is shifted from optical axis 11 of condensing element 10, and light of the first wavelength 27 that is transmitted through optical element 3 therefore is incident to condensing element 10 at a position away from optical axis 11 of condensing element 10 and refracted in condensing element 10. As a result, the direction of incidence of light of the first wavelength 27 into phosphor unit 4 is inclined with respect to the surface of incidence of phosphor unit 4.

The operation of light source device 1 differs according to whether fluorescent regions 12 and 13 are positioned on the path of light of the first wavelength 27 or reflecting region 14 is positioned on the path of light of the first wavelength 27 when light of the first wavelength 27 arrives at phosphor unit 4, and the explanation of the operation is therefore divided between these cases.

The operation when reflecting region 14 of phosphor unit 4 is positioned on the path of light of the first wavelength 27 is first described using FIGS. 3, 4, and 9.

Because reflecting region 14 is positioned on the path of light of the first wavelength 27, light of the first wavelength 27 is reflected by phosphor unit 4. The direction of light of the first wavelength 27 incident to reflecting region 14 is inclined with respect to the surface of incidence of phosphor unit 4, and light of the first wavelength 27 that is reflected by reflecting region 14 therefore is directed toward condensing element 10 while advancing in a direction that intersects with the direction of light of the first wavelength 27 incident to the reflecting region.

Light of first wavelength 27 that is again incident to condensing element 10 is refracted by condensing element 10, and after passing through lenses 16 and 17, arrives at diffusion unit 18. Diffusion unit 18 rotates in correspondence with the rotation of phosphor unit 4, whereby light of the first wavelength 27 that is emitted from lens 16 is diffused by diffusion region 20 of diffusion unit 18 and irradiated into rod integrator 6.

The case when fluorescent region 12 or 13 of phosphor unit 4 is positioned on the path of light of the first wavelength 27 that is incident to phosphor unit 4 is next described using FIGS. 3, 4, and 10.

Because fluorescent region 12 or 13 is positioned on the path of light of the first wavelength 27 that is incident to phosphor unit 4, light of the first wavelength 27 irradiates fluorescent region 12 or 13. As a result, fluorescent region 12 or 13 emits light 28 of the second wavelength that differs from the first wavelength. In the present exemplary embodiment, fluorescent region 12 emits green fluorescent light and fluorescent region 12 emits red fluorescent light.

In FIG. 10, light of the second wavelength 28 is depicted by broken lines to distinguish this light from light of the first wavelength 27.

Fluorescent regions 12 and 13 that emit light of the second wavelength 28 in response to irradiation of light of the first wavelength 27 are also considered to be secondary light sources that use light source main body 2 as the excitation source. Light of the second wavelength 28 that is emitted from fluorescent regions 12 and 13 advances in all directions from the position of irradiation of light of the first wavelength 27 while spreading, particularly toward the side of condensing element 10.

Light of second wavelength 28 that is incident to condensing element 10 is converted to parallel light through the use of condensing element 10 and is directed toward optical element 3 and lens 16.

Of light of the second wavelength 28 that is emitted from optical element 3, light 28a that is directed toward lens 16 arrives at diffusion unit 18 by way of lenses 16 and 17.

Of light of the second wavelength 28 that is emitted from optical element 3, light 28b that is directed toward optical element 3 is reflected in optical element 3. Because the direction of reflection of light of the second wavelength in optical element 3 is the same as the direction of light of the first wavelength 27 that passes through optical element 3, light 28b that is reflected in optical element 3 is again directed toward condensing element 10.

Light 28b that is again incident to condensing element 10 is directed toward phosphor unit 4 and arrives at fluorescent regions 12 and 13. Light 28b that is irradiated into fluorescent regions 12 and 13 undergoes diffused reflection in fluorescent regions 12 and 13 and is therefore again directed toward condensing element 10. In other words, fluorescent regions 12 and 13 function as secondary light sources that emit light in response to the irradiation of light 28b.

A portion of light 28b that is irradiated into fluorescent regions 12 and 13 advances along the path of advance of light 28a and is directed toward rod integrator 6.

Of light 28b that is irradiated into fluorescent regions 12 and 13, the light that is directed toward optical element 3 is again irradiated into fluorescent regions 12 and 13. Due to the repetition of the reflection in optical element 3 and the irradiation into fluorescent regions 12 and 13, most of light of the second wavelength 28 that is emitted from fluorescent regions 12 and 13 is directed toward diffusion unit 18 by way of lenses 16 and 17.

Because diffusion unit 18 rotates in correspondence with the rotation of phosphor unit 4, light of the second wavelength 28 that is incident to diffusion unit 18 passes through transmission region 19 and is then irradiated to rod integrator 6.

Light of first and second wavelengths 27 and 28 that is irradiated into rod integrator 6 is repeatedly reflected inside rod integrator 6 to become a uniform light beam, emitted from rod integrator 6, and is then irradiated into the optical component that is referred to as display panel 23 (see FIG. 5). The projection of a color image is enabled by controlling the modulation of display panel 23 (see FIG. 5) so as to synchronize it with the color of light emitted by light source device 29.

In light source device 29 according to the present exemplary embodiment, light of the first wavelength 27 that is emitted from light source main body 2 does not pass through phosphor unit 4. Accordingly, light source device 29 does not require a reflecting mirror on the side of phosphor unit 4 that is opposite the side that is irradiated by light. As a result, light source device 29 can be made more compact with respect to the direction of irradiation of light to phosphor unit 4.

In addition, light source device 29 does not require a dichroic mirror that separates the S-polarization component and P-polarization component of light of the first wavelength 27 because the direction of reflection of light of the first wavelength 27 in reflecting region 14 intersects the direction of incidence of light of the first wavelength 27 into reflecting region 14. Accordingly, light source device 29 can be fabricated from less expensive parts and the cost of light source device 29 is reduced.

Still further, of light of the second wavelength 28 that is emitted from fluorescent regions 12 and 13, light 28b that is directed toward light source main body 2 is again incident to fluorescent regions 12 and 13 using optical element 3, whereby more light of the second wavelength 28 can be directed in the same direction as light of the first wavelength 27.

In addition, the present exemplary embodiment includes condensing element 10 that converts light of the second wavelength 28 that is emitted from fluorescent regions 12 and 13 to parallel light, whereby most of light of the second wavelength 28 is directed toward optical element 3 and lens 16. As a result, virtually none of light of the second wavelength 28 that is emitted from fluorescent regions 12 and 13 is lost and brighter light of the second wavelength 28 can be emitted in the same direction as light of the first wavelength 27.

### Third Exemplary Embodiment

A light source device according to the third exemplary embodiment of the present invention is next described using FIGS. 11 to 13. Elements that are identical to constituent elements of the first and second exemplary embodiments are given the same reference numbers and redundant explanation is omitted.

FIG. 11 is a schematic upper plan view of the light source device according to the present exemplary embodiment. As shown in FIG. 11, light source device 31 according to the present exemplary embodiment is equipped with separation unit 32 in place of diffusion unit 18 shown in FIG. 1.

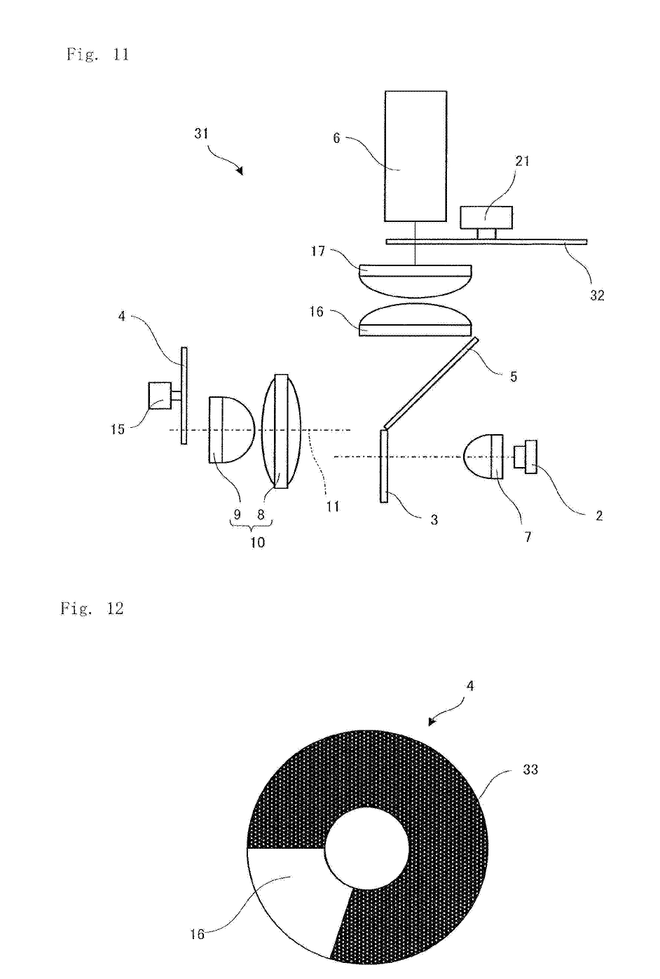

FIG. 12 is a frontal view of phosphor unit 4 that is included in the present exemplary embodiment. As shown in FIG. 12, phosphor unit 4 according to the present exemplary embodiment includes fluorescent region 33 that emits light of the yellow wavelength band in response to irradiation of light of the first wavelength and reflecting region 14. Fluorescent region 33 is formed by fixing, to a predetermined region of a glass plate, a fluorescent material that emits light of the yellow wavelength band in response to irradiation of light of the first wavelength.

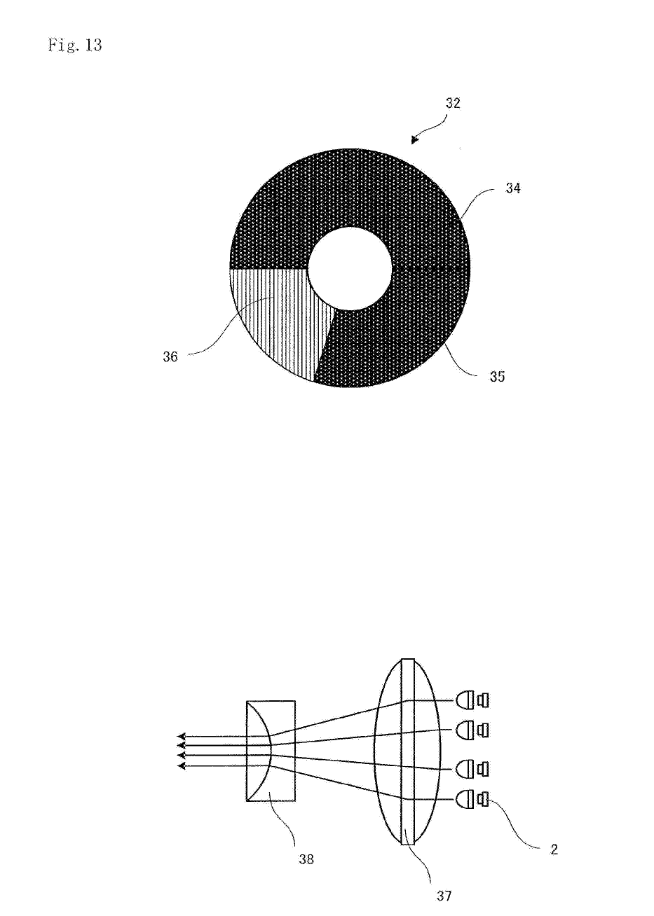

FIG. 13 is a frontal view of separation unit 32 that is included in the present exemplary embodiment. As shown in FIG. 13, separation unit 32 includes green light transmission region 34, red light transmission region 35, and diffusion region 36 corresponding to phosphor unit 4 (see FIG. 12) that includes fluorescent region 33. Green light transmission region 34 has the characteristic of allowing the passage of, of light of the yellow wavelength band, only light of the green wavelength band, and red light transmission region 35 has the characteristic of allowing passage of, of light of the yellow wavelength band, only light of the red wavelength band.

Green light transmission region 34 and red light transmission region 35 are formed by vapor deposition of a dielectric multilayered film on a glass plate under predetermined conditions. The formation of the dielectric multilayered film and the vapor deposition of the dielectric multilayered film on the glass plate are known techniques used when forming a dichroic mirror.

The control of the rotation of phosphor unit 4 and separation unit 32 is here described using FIG. 13.

A case in which green light is irradiated into display panel 23 (see FIG. 5) is first considered.

Phosphor unit 4 is controlled such that fluorescent region 33 of phosphor unit 4 is positioned on the path of light of the first wavelength that is emitted from light source main body 2. In addition, separation unit 32 is controlled such that green light transmission region 34 of separation unit 32 is positioned on the path of light that is incident to rod integrator 6 or light that is emitted from rod integrator 6.

A case is next considered in which red light irradiates display panel 23 (see FIG. 5).

Phosphor unit 4 is controlled such that fluorescent region 33 of phosphor unit 4 is positioned on the path of light of the first wavelength that is emitted from light source main body 2. In addition, separation unit 32 is controlled such that red light transmission region 35 of separation unit 32 is positioned on the path of light that is incident to rod integrator 6 or light that is emitted from rod integrator 6.

A case is next considered in which blue light irradiates display panel 23 (see FIG. 5).

Phosphor unit 4 is controlled such that reflecting region 14 of phosphor unit 4 is positioned on the path of light of the first wavelength that is emitted from light source main body 2. In addition, separation unit 32 is controlled such that diffusion region 36 of separation unit 32 is positioned on the path of light that is incident to rod integrator 6 or light that is emitted from rod integrator 6.

By controlling phosphor unit 4 and separation unit 32 in this way, green, red, and blue light are irradiated into display panel 23 (see FIG. 5). This type of control is made possible by providing position sensors in phosphor unit 4 and separation unit 32. This type of control is realized by applying technology that is used in known projection-type display devices that use color wheels.

In the first to third exemplary embodiments, only one light source main body 2 is provided. However, a plurality of light source main bodies 2 may be aligned as shown in FIG. 14 in the present invention. In this case, a lens system composed of lenses 37 and 28 is preferably used to utilize the light emitted by each individual light source main body 2 as a plurality of parallel light beams of small beam diameter.

The fluorescent material emits more fluorescent light based on an increase in the intensity of the excitation light that excites the fluorescent material. Accordingly, a light source device and a projection-type display device of higher luminance can be obtained by increasing the number of light source main bodies 2 to raise the intensity of light of the first wavelength.

Although the invention of the present application has been described hereinabove with reference to exemplary embodiments, the invention of the present application is not limited to the above-described exemplary embodiments. The configuration and details of the invention of the present application are open to various modifications within the scope of the invention of the present application that will be clear to one of ordinary skill in the art.

### EXPLANATION OF REFERENCE NUMBERS

1 light source device
2 light source main body
3 optical element
4 phosphor unit
5 reflecting mirror
6 rod integrator
7 collimator lens
8 lens
9 lens
10 condensing element
11 optical axis
12 fluorescent region
13 fluorescent region
14 reflecting region
15 motor
16 lens
17 lens
18 diffusion unit
19 transmission region
20 diffusion region
21 motor
22 TIR prism
23 display panel
24 projection lens
25 lens
26 lens
27 light of the first wavelength
28 light of the second wavelength
29 light source device
30 light path conversion element
31 light source device
32 separation unit 32
33 fluorescent region
34 green light transmission region
35 red light transmission region
36 diffusion region
37 lens
38 lens

1. A light source device comprising:
a light source main body that emits light of a first wavelength;
an optical element that is provided on the path of advance of said light of the first wavelength that is emitted from said light source main body and that both transmits light of the first wavelength and reflects light of a second wavelength that differs from the first wavelength;
a phosphor unit that includes a reflecting region that reflects light and a fluorescent region that emits said light of second wavelength in response to irradiation by said light of first wavelength and that is provided such that said light of first wavelength that is transmitted through said optical element sequentially irradiates said reflecting region and said fluorescent region; and
a condensing element that both converts said light of second wavelength that is emitted from said fluorescent region to parallel light and condenses said light of second wavelength that is reflected at said optical element;
wherein:
the optical axis of said light source main body is shifted from the optical axis of said condensing element;
the direction of reflection of said light of first wavelength in said reflecting region intersects the direction of the said light of first wavelength incident to said reflecting region;
in response to irradiation by said light of first wavelength, said fluorescent region emits said light of second wavelength in a direction opposite to said direction of incidence and in said direction of reflection, and further, is capable of reflecting said light of second wavelength that is incident to the fluorescent region; and
the direction of reflection of said light of second wavelength in said optical element is the same as the direction of said light of first wavelength that is transmitted by the optical element.

2. The light source device as set forth in claim 1, wherein:
said optical element is arranged only on the side of the position of incidence of said light of first wavelength to said condensing element from the optical axis of said condensing element.

3. The light source device as set forth in claim 1, further comprising:
a reflecting mirror that is provided on the path of advance of said light of first wavelength that is reflected in said reflecting region.

4. The light source device as set forth in claim 1, wherein:
said fluorescent region includes a green fluorescent region that emits green fluorescent light in response to irradiation of said light of first wavelength and a red fluorescent region that emits red fluorescent light in response to irradiation of said light of first wavelength.

5. The light source device as set forth in claim 1, further comprising:
a diffusion unit that diffuses said light of first wavelength that is reflected in said reflecting region.

6. A light source device as set forth in claim 1, wherein:
said light of second wavelength is light of a yellow wavelength band;
said light source device further comprises a separation unit that includes a green light transmission region that transmits, of said light of yellow wavelength band, only light of a green wavelength band, and a red light transmission region that transmits, of said light of yellow wavelength band, only light of a red wavelength band; and
said separation unit is provided such that said light of yellow wavelength band that is emitted from said phosphor unit sequentially irradiates said green light transmission region and said red light transmission region.

7. The light source device as set forth in claim 6, wherein:
said separation unit further comprises a diffusion unit that diffuses said light of first wavelength that is reflected in said reflecting region.

8. A projection-type display device comprising:
the light source device as set forth in claim 1; and
a display panel that uses light emitted from said light source device to form an image.
